(19) United States
(12) Patent Application Publication
(10) Pub. No.: US 2007/0035412 A1
(43) Pub. Date: Feb. 15, 2007

(54) Application of profiles in a wireless device to control a remote control apparatus

(76) Inventors: Joseph L. Dvorak, Boca Raton, FL (US); Alan R. Beatty, Plantation, FL (US); Stephen O. Bozzone, Lauderhill, FL (US); David J. Hayes, Lake Worth, FL (US); Sybren D. Smith, Plantation, FL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 11/202,539

(22) Filed: Aug. 12, 2005

(51) Int. Cl. G08C 19/00

(52) U.S. Cl. 340/825.69; 340/825.22; 455/556.1; 446/456

(57) ABSTRACT

A system (10) or method (50) for controlling remote controlled apparatus can include a remote controlled apparatus (18) and a remote controlling device (12). The remote controlling device can include a wireless transceiver (9) for controlling the remote controlled apparatus and a programmable memory (16) for storing profiles defining operation of the remote controlling device corresponding to the remote controlled apparatus. The wireless transceiver receives from the remote controlled apparatus data defining a profile or a selection signal for selecting among a plurality of stored profiles. The remote controlled apparatus can be an RC toy such as a car, boat or aircraft and the remote controlling device can be a phone or other transceiving device. The remote controlled apparatus can include a stored profile that can be modified using an exchangeable housing (26, 28 or 44) having a predefined set of mechanisms for activating switches on the remote controlled apparatus.

### FIELD OF THE INVENTION

This invention relates generally to remote controlled systems, and more particularly to the use of profiles in defining the operation of remote controlled systems.

### BACKGROUND OF THE INVENTION

Remote controlled (RC) apparatus and particularly remote controlled toys have traditionally used one-way communications to control the operation of the RC apparatus. A change at the RC apparatus would not affect the operation of a remote controlling device that is controlling the RC apparatus. Furthermore, events that occur at the RC apparatus have no corresponding affect at the remote controlling device to give a user of the remote controlling device a more realistic feel of the events.

### SUMMARY OF THE INVENTION

Embodiments in accordance with the present invention can utilize profiles that can be stored and modified at either a RC apparatus or a remote controlling device or both to enhance user entertainment and enjoyment of the remotely controlled experience.

In a first embodiment of the present invention, a remote controlling device can include a wireless transceiver for controlling one or more remote controlled apparatus and a programmable memory for storing one or more profiles defining operation of the remote controlling device which corresponds to the one or more remote controlled apparatus, wherein the wireless transceiver receives from the remote controlled apparatus data defining a profile or a selection signal for selecting among a plurality of stored profiles at the remote controlling device. The remote controlled apparatus can be a remote controlled car, a remote controlled boat, a remote controlled aircraft, or a remote controlled robot for example and the remote controlling device can be a cellular phone (or any number or other wireless devices) where the one or more profiles control the capabilities and behavior of the cellular phone. The profile or profiles can control parameters for the remote controlling device among vibrational aspects, sounds, or visual skin types presented to a user. The profile(s) can be further defined by accessory components coupled to the remote controlling device. The profile(s) can also control a period of time or a utilization measurement of the remote controlled apparatus and can also define a personality of the operation of the remote controlled apparatus. The profiles can also use a digital rights management component to enable the exchanging of profiles and to prevent the cloning of profiles.

In a second embodiment of the present invention, a system for controlling remote controlled apparatus using profiles can include a remote controlled apparatus and a remote controlling device. The remote controlling device can include a wireless transceiver for controlling the remote controlled apparatus and a programmable memory for storing one or more profiles defining operation of the remote controlling device which corresponds to the remote controlled apparatus, wherein the wireless transceiver receives from the remote controlled apparatus data defining a profile or a selection signal for selecting among a plurality of stored profiles at the remote controlling device. As mentioned above, the remote controlled apparatus can be an RC toy such as a car, boat, aircraft, or robot and the remote controlling device can be a wireless device such as a cellular phone. In addition to the aspects of profiles discussed above, the remote controlled apparatus can include a profile stored that can be modified using an exchangeable housing having a predefined set of mechanisms for activating switches on the remote controlled apparatus, or using a radio frequency identifier embedded in the exchangeable housing, or using dip switches on the remote controlled apparatus, or receiving an over-the-air upgrade of profile information received at the remote controlling device, or using an add on memory card coupled to the remote controlled apparatus or the remote controlling device.

In a third embodiment, remote controlled apparatus using profiles and controlled by a remote controlling device having a transceiver can include a wireless transceiver for being remotely controlled by the remote controlling device and a programmable memory for storing one or more profiles, wherein the wireless transceiver in the remote controlled apparatus data transmits a profile or a selection signal for indicating selection among a plurality of stored profiles defining operation of at least one among the remote controlling device or the remote controlled apparatus.

In a fourth embodiment of the present invention, a method of modifying the behavior of a remote controlled system can include the steps of storing a profile defining operation of a remote controlling device which controls a remote controlled apparatus, receiving data from the remote controlled apparatus further defining the profile, and controlling the remote controlling device in accordance with the profile. The method can further include the step of controlling the remote controlled apparatus in accordance with the profile. The method can further include the step of modifying the profile using an exchangeable housing having a predefined set of mechanisms for activating switches on the remote controlled apparatus, or using a radio frequency identifier embedded in the exchangeable housing, or using dip switches on the remote controlled apparatus, or receiving an over-the-air upgrade of profile information received at the remote controlling device, or using an add on memory card coupled to the remote controlled apparatus or the remote controlling device.

Other embodiments, when configured in accordance with the inventive arrangements disclosed herein, can include a system for performing and a machine readable storage for causing a machine to perform the various processes and methods disclosed herein.

### BRIEF DESCRIPTION OF THE DRAWINGS

FIG. 1 is an illustration of a remote controlled system using profiles in accordance with an embodiment of the present invention.

FIG. 2 is a remote controlled apparatus using an exchangeable housing having a mechanism for activating a predetermined profile in accordance with an embodiment of the present invention.

FIG. 3 is the remote controlled apparatus of FIG. 2 using a different exchangeable housing including a mechanism for activating yet another predetermined profile in accordance with an embodiment of the present invention.

FIG. 4 is the remote controlled apparatus of FIG. 2 using a different exchangeable housing including an RFID device or a separate memory device for activating another predetermined profile in accordance with an embodiment of the present invention.

FIG. 5 is a flow chart illustrating a method of modifying the behavior of a remote controlled system in accordance with an embodiment of the present invention.

### DETAILED DESCRIPTION OF THE DRAWINGS

While the specification concludes with claims defining the features of embodiments of the invention that are regarded as novel, it is believed that the invention will be better understood from a consideration of the following description in conjunction with the figures, in which like reference numerals are carried forward.

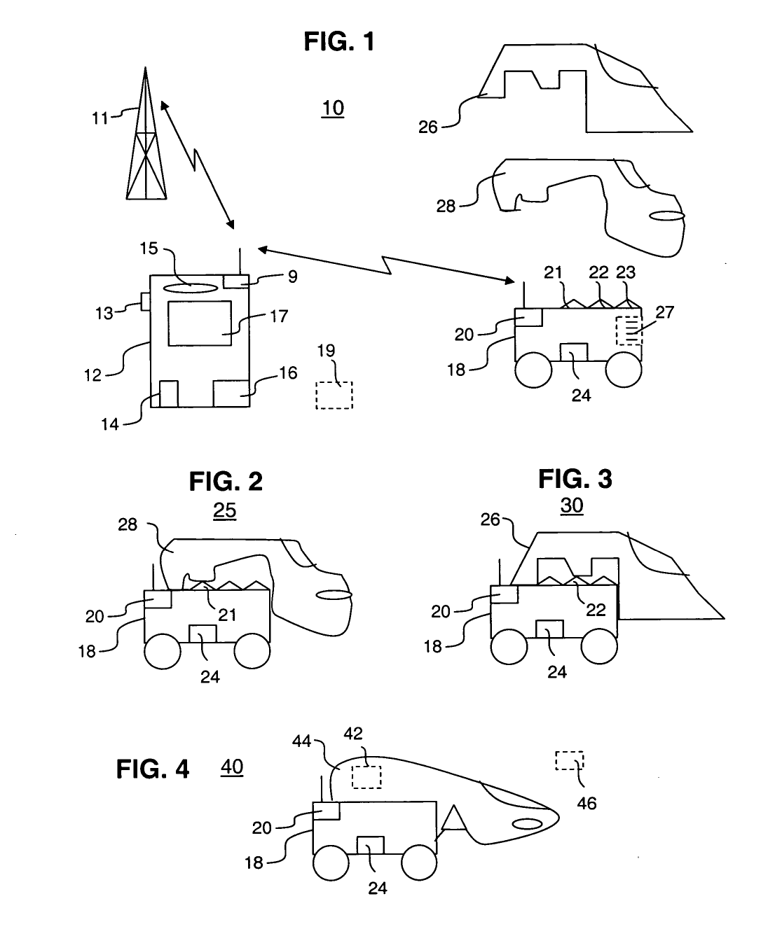

Referring to FIG. 1, a system 10 is illustrated that controls a remote controlled apparatus 18 at least in part using profiles. The system 10 can include the remote controlled apparatus 18 and a remote controlling device 12. The remote controlling device 12 can include a wireless transceiver 9 for controlling the remote controlled apparatus 18 and a programmable memory 16 for storing one or more profiles defining operation of the remote controlling device 12 which corresponds to the remote controlled apparatus 18, wherein the wireless transceiver 9 receives from the remote controlled apparatus 18 data defining a profile or a selection signal for selecting among a plurality of stored profiles at the remote controlling device 12. The remote controlled apparatus 18 can be an RC toy such as a car, boat, aircraft, or robot and the remote controlling device 12 can be a wireless device such as a cellular phone although other wireless devices such as two-way radios, satellite phones, wireless laptops, smart phones and game controllers (such as wireless joysticks) are certainly contemplated herein and within the scope of the claims. Note, the wireless transceiver in the remote controlling device and in the remote controlled apparatus can use any number of communication protocols for communication including the IEEE 802.15.4 Standard for communication.

In one embodiment, the remote controlling device 12 can be a cellular phone including the transceiver 9 that is not only in communication with the remote controlled apparatus 18, but with a base station or carrier via a communication tower or antenna 11. The remote controlling device 12 can further include additional components such as a programmable memory or processor 16, a display 17, a vibrating device 14, a speaker 15, and a push-to-talk (PTT) or push-to-activate (PTX) button 13. The device 12 can also include other components such as microphones, cameras, keypads and other accessories (not shown) that are typically found with cellular phones. The remote controlling device 12 can further include an interface (such as USB 2.0 or PCMCIA or compact flash to name a few) for receiving an optional memory device 19 such as a memory card or memory stick which can contain further information defining a profile. The memory device 19 can couple to the programmable memory or processor 16.

The remote controlled apparatus 18 as illustrated in FIGS. 1-4 can include a transceiver 20 and programmable memory or processor 24. Optionally, the remote controlled apparatus 18 can include contact points or popple switches 21, 22, and 23 that can be selectively activated based upon the structure of the mating housing enclosure that mates with the remote controlled apparatus 18. The contact points or switches 21, 22, and 23 can be used to define alternative profiles for the remote controlled apparatus 18 or the remote controlling device 12 or both. In yet another alternative, the remote controlled apparatus 18 can include a set of dip switches 27 that can also be used to choose among profiles.

One or more profiles can be stored in either the remote controlled apparatus 18 or the remote controlling device 12 or both. The manner in which profiles can be loaded, modified, changed, or replaced can be embodied in a myriad of different mechanisms as contemplated herein. For example, the remote controlled apparatus 18 can include a profile stored that can be modified using an exchangeable housing 26 or 28 or 44 as shown in FIGS. 2, 3, or 4 respectively having a predefined set of mechanisms for activating switches on the remote controlled apparatus 18. In FIG. 2, the arrangement 25 uses the structure of housing 28 to contact or activate contact or switch 21, whereas the arrangement 30 of FIG. 3 uses the structure of housing 26 to contact or activate contact or switch 22 instead. In the arrangement 40 of FIG. 4, the exchangeable housing 44 can include a radio frequency identifier (RFID) 42 embedded in the exchangeable housing 44. The remote controlled apparatus 18 can further include an interface (such as USB 2.0 or PCMCIA or compact flash to name a few) for receiving an optional memory device 46 such as a memory card or memory stick which can contain further information defining a profile. The memory device 46 can couple to the programmable memory or processor 24. In yet another alternative, the remote controlling device 12 can receive an over-the-air upgrade of profile information from the base station 11 which can be forwarded over-the-air to the remote controlled apparatus 18 if needed.

A profile can be a series of specifications that defines the experience on the remote controlling device 12 (such as a radio handset) of what the remote control apparatus 18 goes through. The profile can place constraints on the performance of either the remote control apparatus 18 or the remote controlling device 12 or both. As another example consider Radio Controlled (RC) cars. Actual automobile manufacturers such as Ford or Ferrari can have drastically different performance specifications for their various models. Correspondingly, the profile can define what sensations and content a user of a particular model of RC car would experience on the handset and likewise can modify the performance specifications or other aspects of the RC car.

As mentioned above, a profile can include a myriad of controllable parameters that will be listed below, but should not be understood to be an exhaustive or comprehensive list of all the possible parameters that can be controlled as contemplated herein. A profile can include controllable parameters for the handset or remote controlled device such as:

1. A user friendly name that is editable by an owner.

2. Vibrational aspects, for example distinguishing between a smooth ride (an expensive or high performance device) versus a bumpy ride (a low cost or low performance device). This could apply to many RC devices such as car, boats and aircraft. The handset can also use the vibration device 14 in the handset (12) to implement corresponding haptics experienced by the remote controlled device 18.

3. Sounds rendered by the handset and heard by the user about the apparatus. For example, a purring motor of a car versus a putt - putt bang bang sound of a go cart.

4. Relative strength of a specified area of the apparatus when experiencing an impact. The handheld device can be alerted when the specified area (front, rear, left or right side of the apparatus) has been impacted. The device performance can be affected once a number of impacts to the specified area reach a predetermined threshold. Specific applications can be implemented for a demolition derby or NASCAR-like racing. In a “space” or “boating” scenario, “shields can go down” once the remote controlled apparatus 18 has been impacted a predetermined number of times. In combat vehicles such as a remote-controlled tanks, the device can track how many “hits” it has taken and disable certain functionalities based on those “hits”.

5. Visual skin types can be presented to the user on the phone display 17 along with all the device display indicators based on a profile. If a camera is used on the remote controlled device 18, the profile can define the angle or mode of display for viewing on the display 17 for example.

6. The capabilities of the remote controlling device 12 (such as a phone) can also vary based on a current profile. A capability that is in one profile can also be missing in another profile. For example, the push-to-talk (PTT button) can operate normally in one profile and in another can serve to provide instant power (as in a fuel enhancement for drag racing) to the remote controlled device 18. Other examples include accessing a user's calendar on the handset (12) and having the car or other remote apparatus indicate a critical appointment. Yet another example can turn lights on or off on the remote control apparatus 18 based on the time of day from the user's handset. Note, the remote controlling device 12 is not limited to phone, and thus the profile can modify almost any number of applicable capabilities on almost any electronic device having a wireless connection. For example, many different devices such as a Personal Digital Assistant or laptop computer can have a Bluetooth transceiver embedded or coupled thereto.

7. A listing of accessory components and their respective capabilities utilized with the remote controlling device 12 to control the device that brings about additional features / capabilities, e.g. a plug-in accessory for steering and speed control that allows for tighter and more responsive cornering versus using a 4 or 5 way navigational keys that might be available at the remote controlling device 12.

8. Vehicle capabilities can be stored in a memory location of the remote controlled apparatus 18 with the proper settings corresponding to the type of automobile or other apparatus. Potential settings that can be stored on the vehicle include control type (e.g. skid control vs servo steer), steering center, default forward speed, maximum forward speed, maximum launcher speed and names of controls such as left signal, right signal, running lights, brakes, horn, missile launcher to name a few. A different purchased or modified profile can change some of the performance characteristics such as the maximum forward speed (for example, when changing a body style from a Ford to a Ferrari) and virtual gear capabilities.

9. A Profile can also define or set a period of time or an amount of utilization authorized. For example, the profile can have leased period options such as an indefinite period (when the car and profile are both paid for up-front), or a time lease (based on a particular length of time that the device can be used), or a utilization lease (based on for example a number of hours or laps such as 100 hours of engine running or a 100 laps).

10. A profile can also specify a particular personality of a user when operating the remote control apparatus such as a “28 year old aggressive male driver” or a “80 year old cautious driver”. This portion of the profile can be bought, created or edited by the user. Commands from the user's handset can be sent to other participants in a game as actions performed by two or more remote control apparatus are experienced. For example, when one car bumps another car and causes it to wreck, a command sent from the “aggressive” type driver can be sent to the victim playing somber music or other appropriate jingle on the victims handset while a command or other music melody can be sent to the originator's car playing against the victim's car.

11. A profile can depict a personal strategy of the device performance (e.g., driving for a car), device capabilities and user interface aspects of the corresponding real word individual and device. For example, individual race car drivers can have a particular profile that modifies not only the look and feel of the user interface, but the performance of the remote controlled apparatus 18. This can utilize existing profile information already created in this list.

12. A profile can determine the behavior of a phone or handset when other events occur, such as a phone call, a dispatch or message coming in, or other event. Updateable options in the profile to determine device behavior can include: 1. Auto forward calls to voice mail when using a toy application. 2. Auto forward selected calls or let through certain calls. 3. Allow applications to be suspended and force the remote controlled apparatus 18 into a holding pattern or come home (such as returning towards the controlling device). 4. Prompt a user on incoming call.

13. A profile can contain information related to a virtual fuel tank or gas gauge. Different models of a remote controlled apparatus 18 (such as an economy car versus a truck or race car) can have different fuel tank limits (not correlated to battery level) that can be used during specific events (such as NASCAR style racing for cars)

As noted above, a profile can have features for locking or sharing profiles so that profiles for a particular car or user is restricted in terms of copying, yet exchanging of profiles might be allowed. In one implementation, a handset can utilize a digital rights management component that can be implemented in cellular phones. A certificate along with a profile can be given to another user, but not necessarily cloned.

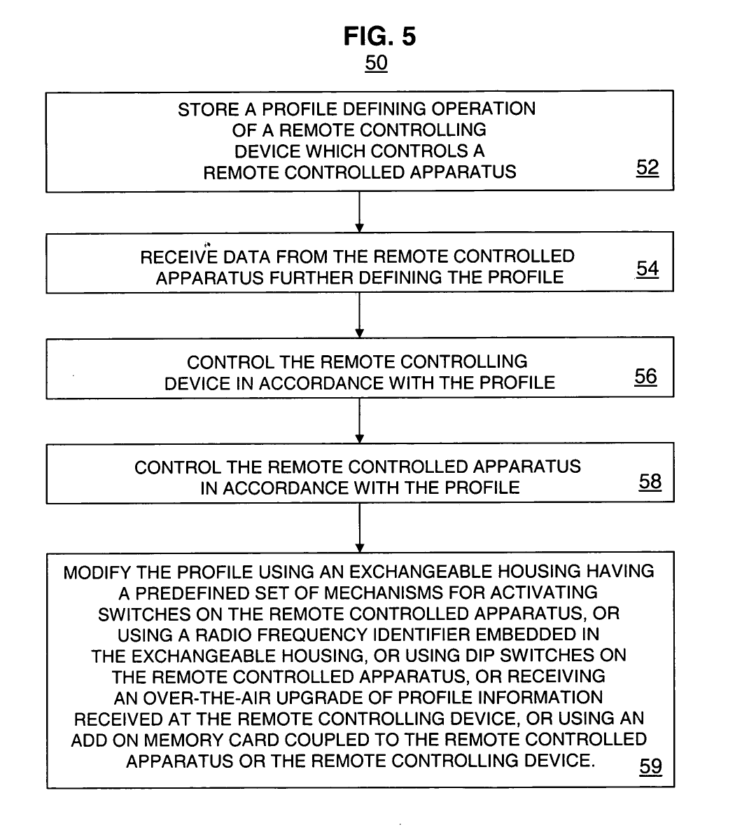

Referring to FIG. 5, a method 50 of modifying the behavior of a remote controlled system can include the step 52 of storing a profile defining operation of a remote controlling device which controls a remote controlled apparatus, receiving data from the remote controlled apparatus further defining the profile at step 54, and controlling the remote controlling device in accordance with the profile at step 56. The method 50 can further include the step 58 of controlling the remote controlled apparatus in accordance with the profile. The method 50 can further include the step 59 of modifying the profile using an exchangeable housing having a predefined set of mechanisms for activating switches on the remote controlled apparatus, or using a radio frequency identifier embedded in the exchangeable housing, or using dip switches on the remote controlled apparatus, or receiving an over-the-air upgrade of profile information received at the remote controlling device, or using an add on memory card coupled to the remote controlled apparatus or the remote controlling device.

In light of the foregoing description, it should be recognized that embodiments in accordance with the present invention can be realized in hardware, software, or a combination of hardware and software. A system according to the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the functions described herein, is suited. A typical combination of hardware and software could be a general purpose computer system with a computer program that, when being loaded and executed, controls the computer system such that it carries out the functions described herein.

In light of the foregoing description, it should also be recognized that embodiments in accordance with the present invention can be realized in numerous configurations contemplated to be within the scope and spirit of the claims. Additionally, the description above is intended by way of example only and is not intended to limit the present invention in any way, except as set forth in the following claims.

What is claimed is:

1. A remote controlling device, comprising:
a wireless transceiver for controlling one or more remote controlled apparatus; and
a programmable memory for storing one or more profiles defining operation of the remote controlling device which corresponds to the one or more remote controlled apparatus, wherein the wireless transceiver receives from the remote controlled apparatus data defining a profile or a selection signal for selecting among a plurality of stored profiles at the remote controlling device.

2. The remote controlling device of claim 1, wherein the one or more remote controlled apparatus can be a remote controlled car, a remote controlled boat, a remote controlled aircraft, or a remote controlled robot.

3. The remote controlling device of claim 1, wherein the one or more profiles control parameters for the remote controlling device among vibrational aspects, sounds, or visual skin types presented to a user.

4. The remote controlling device of claim 1, wherein the remote controlling device is a cellular phone and the one or more profiles control the capabilities and behavior of the cellular phone.

5. The remote controlling device of claim 1, wherein the one or more profiles are further defined by accessory components coupled to the remote controlling device.

6. The remote controlling device of claim 1, wherein the one or more profiles control one or more among a period of time or a utilization measurement of the remote controlled apparatus.

7. The remote controlling device of claim 1, wherein the one or more profiles define a personality of the operation of the remote controlled apparatus.

8. The remote controlling device of claim 1, wherein the one or more profile use a digital rights management component to enable the exchanging of profiles and to prevent the cloning of profiles.

9. A system for controlling remote controlled apparatus using profiles, comprising:
a remote controlled apparatus; and
a remote controlling device, comprising:
a wireless transceiver for controlling the remote controlled apparatus; and
a programmable memory for storing one or more profiles defining operation of the remote controlling device which corresponds to the remote controlled apparatus, wherein the wireless transceiver receives from the remote controlled apparatus data defining a profile or a selection signal for selecting among a plurality of stored profiles at the remote controlling device.

10. The system of claim 9, wherein the controlled apparatus can be a remote controlled car, a remote controlled boat, a remote controlled robot, or a remote controlled aircraft.

11. The system of claim 9, wherein the one or more profiles control parameters for the remote controlling device among vibrational aspects, sounds, or visual skin types presented to a user.

12. The system of claim 9, wherein the remote controlling device is a cellular phone and the one or more profiles control the capabilities and behavior of the cellular phone.

13. The system of claim 9, wherein the one or more profiles are further defined by accessory components coupled to the remote controlling device.

14. The system of claim 9, wherein the one or more profiles control one or more among a period of time or a utilization measurement of the remote controlled apparatus.

15. The system of claim 9, wherein the one or more profiles defines a personality of the operation of the remote controlled apparatus.

16. The system of claim 9, wherein the one or more profile use a digital rights management component to enable the exchanging of profiles and to prevent the cloning of profiles.

17. The system of claim 9, wherein the remote controlled apparatus further comprises a profile stored at the remote controlled apparatus that can be modified using an exchangeable housing having a predefined set of mechanisms for activating switches on the remote controlled apparatus, or using a radio frequency identifier embedded in the exchangeable housing, or using dip switches on the remote controlled apparatus, or receiving an over-the-air upgrade of profile information received at the remote controlling device, or using an add on memory card coupled to the remote controlled apparatus or the remote controlling device.

18. A method of modifying the behavior of a remote controlled system, comprising the steps of:
storing a profile defining operation of a remote controlling device which controls a remote controlled apparatus; receiving data from the remote controlled apparatus further defining the profile; and
controlling the remote controlling device in accordance with the profile.

19. The method of claim 18, wherein the method further comprises the step of controlling the remote controlled apparatus in accordance with the profile.

20. The method of claim 19, wherein the method further comprises the step of modifying the profile using an exchangeable housing having a predefined set of mechanisms for activating switches on the remote controlled apparatus, or using a radio frequency identifier embedded in the exchangeable housing, or using dip switches on the remote controlled apparatus, or receiving an over-the-air upgrade of profile information received at the remote controlling device, or using an add on memory card coupled to the remote controlled apparatus or the remote controlling device.

21. A remote controlled apparatus using profiles and controlled by a remote controlling device having a transceiver, comprising:
a wireless transceiver for being remotely controlled by the remote controlling device; and
a programmable memory for storing one or more profiles, wherein the wireless transceiver in the remote controlled apparatus data transmits a profile or a selection signal for indicating selection among a plurality of stored profiles defining operation of at least one among the remote controlling device or the remote controlled apparatus.

22. The remote controlled apparatus of claim 21, wherein the remote controlled apparatus further comprises a profile stored at the remote controlled apparatus that can be modified using an exchangeable housing having a predefined set of mechanisms for activating switches on the remote controlled apparatus, or using a radio frequency identifier embedded in the exchangeable housing, or using dip switches on the remote controlled apparatus, or receiving an over-the-air upgrade of profile information received at the remote controlling device, or using an add on memory card coupled to the remote controlled apparatus or the remote controlling device.

23. The system of claim 21, wherein the controlled apparatus can be a remote controlled car, a remote controlled boat, a remote controlled robot, or a remote controlled aircraft.
